(19) United States
(12) Patent Application Publication
(10) Pub. No.: US 2011/0113447 A1
(43) Pub. Date: May 12, 2011

(54) IMAGE DISPLAY APPARATUS AND OPERATION METHOD THEREFOR

(75) Inventor: Youngkook JUNG, Seoul (KR)

(73) Assignee: LG Electronics Inc.

(21) Appl. No.: 12/902,765

(22) Filed: Oct. 12, 2010

(30) Foreign Application Priority Data
Nov. 11, 2009 (KR) 10-2009-0108710

(51) Int. Cl. H04N 5/445

(52) U.S. Cl. 725/41

(57) ABSTRACT

A method and apparatus may be provided. A plurality of thumbnail images may be generated based on received television signals, the thumbnail image being at least one of a still image or a moving image. A thumbnail list may be sent for output on the display. The thumbnail list may include a portion or all of the plurality of thumbnail images. A thumbnail image may be identified as belonging to one of a plurality of groups, each group being classified based on at least one of a prescribed setting or data of the television signal. Additionally, based on the groups, the thumbnail images belonging to one group may be differentiated based on at least one of color or icon from the thumbnail images belonging to another group.

### CROSS-REFERENCE TO RELATED APPLICATION

This application claims priority benefit from Korean Patent Application No. 10-2009-0108710, filed Nov. 11, 2009, the subject matter of which is incorporated herein by reference.

### BACKGROUND

1. Field

Embodiments may relate to an image display apparatus and an operation method therefore. More particularly, embodiments may relate to an image display apparatus and an operation method for enabling a user to identify contents of a broadcast signal received on a channel intuitively and efficiently.

2. Background

An image display apparatus may display images viewable to a user. The image display apparatus may display a broadcasting program selected by a user on a display from among broadcasting programs transmitted from broadcasting stations. A recent trend in broadcasting is a shift from analog broadcasting to digital broadcasting.

Digital broadcasting may offer advantages over analog broadcasting such as robustness against noise, less data loss, ease of error correction, and/or the ability to provide high-definition, clear images. Digital broadcasting may allow interactive services for viewers.

As broadcast channels increase in number to meet various user demands, it may become more difficult for viewers to determine what programs they are watching as they switch through channels. Therefore, much time may be taken to select a channel.

### BRIEF DESCRIPTION OF THE DRAWINGS

Arrangements and embodiments may be described in detail with reference to the following drawings in which like reference numerals refer to like elements and wherein:

FIG. 1 is a block diagram of an image display apparatus according to an exemplary embodiment of the present invention;

FIG. 2 is a block diagram of a channel browsing processor shown in FIG. 1;

FIGS. 3A and 3B are diagrams illustrating examples of a remote controller shown in FIG. 1;

FIG. 4 is a block diagram of a user Input/Output (I/O) portion in an interface shown in FIG. 1 and a pointing device shown in FIG. 3;

FIGS. 5A to 7B illustrate examples of screens displayed on a display according to exemplary embodiments of the present invention; and

FIG. 8 is a flowchart of a method for operating an image display apparatus according to an exemplary embodiment of the present invention.

### DETAILED DESCRIPTION

Exemplary embodiments of the present invention may be described below with reference to the attached drawings.

The terms “module” and “portion” attached to describe names of components/elements may be used herein to help understanding of the components and thus should not be considered as having specific meanings and/or roles. Accordingly, the terms “module” and “portion” may be interchangeable in their use.

The following discussion may relate to broadcast signals. Other or similar signals may also be used such as television signals, a cable signal and/or any type of received signal from a content provider or a cable provider.

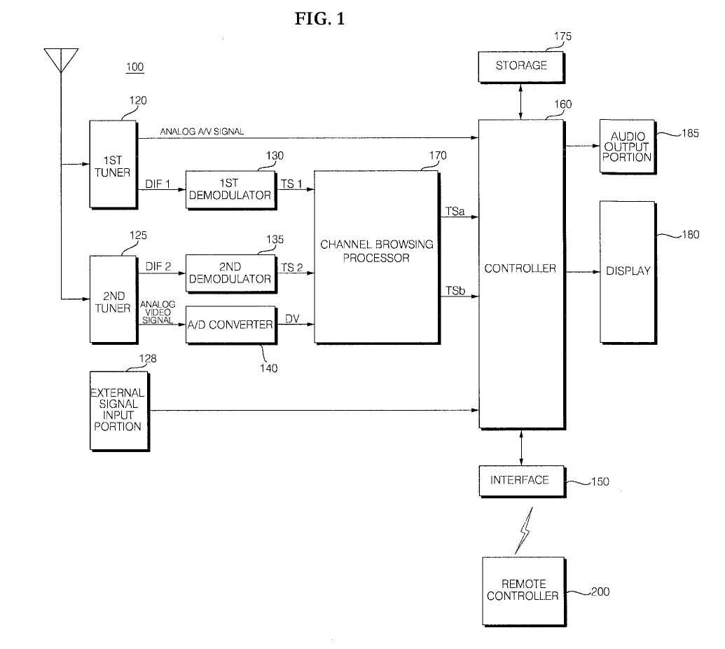

FIG. 1 is a block diagram of an image display apparatus according to an exemplary embodiment of the present invention. Other embodiments and configurations are also within the scope of the present invention.

As shown in FIG. 1, an image display apparatus 100 may include a first tuner 120, a second tuner 125, an external signal input portion 128, a first demodulator 130, a second demodulator 135, an Analog-to-Digital (A/D) converter 140, an interface 150, a controller 160, a channel browsing processor 170, a storage 175 (or memory), a display 180, and an audio output portion 185.

The first tuner 120 may select a Radio Frequency (RF) broadcast signal corresponding to a channel selected by a user from among a plurality of RF broadcast signals received through an antenna and downconvert the selected RF broadcast signal to a digital Intermediate Frequency (IF) signal or an analog baseband Audio/Video (A/V) signal. More specifically, if the selected RF broadcast signal is a digital broadcast signal, the first tuner 120 may downconvert the selected RF broadcast signal to a digital IF signal DIF 1. On the other hand, if the selected RF broadcast signal is an analog broadcast signal, the first tuner 120 may downconvert the selected RF broadcast signal to an analog baseband A/V signal CVBS 1/SIF. The first tuner 120 may be a hybrid tuner capable of processing not only digital broadcast signals but also analog broadcast signals. The analog baseband A/V signal CVBS1/SIF may be directly input to the controller 160.

The first tuner 120 may receive RF broadcast signals from an Advanced Television Systems Committee (ATSC) single-carrier system or from a Digital Video Broadcasting (DVB) multi-carrier system, as may be described below.

The second tuner 125, like the first tuner 120, may select the RF broadcast signal corresponding to the channel selected by the user from among the plurality of RF broadcast signals received through the antenna, and may downconvert the selected RF broadcast signal to a second digital IF signal DIF 2 or an analog baseband A/V signal.

The second tuner 125 may sequentially or periodically select a number of RF broadcast signals corresponding to all broadcast channels previously added to the image display apparatus 100 by a channel add function from a plurality of RF signals received through the antenna, and may downconvert the selected RF broadcast signals to IF signals or baseband A/V signals. One or more video frames acquired from each of the previously-added channels may be displayed on at least a part of the display 180 as a thumbnail image. Thus, the RF broadcast signals corresponding to all of the previously-added channels may be sequentially or periodically received.

For example, the first tuner 120 may downconvert a main RF broadcast signal selected by the user to an IF signal or a baseband A/V signal, and the second tuner 125 may sequentially or periodically select all RF broadcast signals or all other RF broadcast signals (i.e., sub-RF broadcast signals) except for the main RF broadcast signal and downconvert the selected RF broadcast signals to IF signals or baseband A/V signals.

The first demodulator 130 may receive the first digital IF signal DIF 1 from the first tuner 120 and may demodulate the first digital IF signal DIF 1.

For example, if the first digital IF signal DIF 1 is an ATSC signal, the first demodulator 130 may perform 8-Vestigal SideBand (VSB) demodulation on the first digital IF signal DIF 1. The first demodulator 130 may also perform channel decoding. For the channel decoding, the first demodulator 130 may include a Trellis decoder (not shown), a de-interleaver (not shown) and a Reed-Solomon decoder (not shown) and/or may perform Trellis decoding, de-interleaving and Reed-Solomon decoding.

For example, if the first digital IF signal DIF 1 is a DVB signal, the first demodulator 130 may perform Coded Orthogonal Frequency Division Multiple Access (COFDMA) demodulation on the first digital IF signal DIF 1. The first demodulator 130 may also perform channel decoding. For the channel decoding, the first demodulator 130 may include a convolution decoder (not shown), a de-interleaver (not shown), and a Reed-Solomon decoder (not shown) and/or may perform convolution decoding, de-interleaving, and Reed-Solomon decoding.

The external signal input portion 128 may receive signals from an external device. For reception of the external input signals, the external signal input portion 128 may include an A/V Input/Output (I/O) portion (not shown) and a wireless communication module (not shown).

The external signal input portion 128 may be connected to an external device such as a Digital Versatile Disc (DVD), a Bluray disc, a gaming device, a camcorder, and/or a computer (e.g., a laptop computer). The external signal input portion 128 may externally receive video, audio, and/or data signals from the external device and transmit the received external input signals to the controller 160. The external signal input portion 128 may output video, audio, and data signals processed by the controller 160 to the external device.

In order to receive or transmit A/V signals from or to the external device, the A/V I/O portion of the external signal input portion 128 may include an Ethernet port, a Universal Serial Bus (USB) port, a Composite Video Banking Sync (CVBS) port, a component port, a Super-video (S-video) (analog) port, a Digital Visual Interface (DVI) port, a High-Definition Multimedia Interface (HDMI) port, a Red-Green-Blue (RGB) port, a D-sub port, an Institute of Electrical and Electronics Engineers (IEEE)-1394 port, a Sony/Philips Digital Interconnect Format (S/PDIF) port, and/or a LiquidHD port.

Input signals received through the external signal input portion 128 may be input to the channel browsing processor 170 and may be subjected to a channel browsing operation performed by the channel browsing processor 170 for extracting a number of thumbnail images. For example, analog signals received through the CVBS port and the S-video port may be converted into digital signals by the A/D converter 140 and then input to the channel browsing processor 170. Digital signals received through the Ethernet port, the USB port, the component port, the DVI port, the HDMI port, the RGB port, the D-sub port, the IEEE-1394 port, the S/PDIF port and the LiquidHD port may be directly input to the channel browsing processor 170 without the need for A/D conversion. A digital signal output from the external signal input portion 128 may be a stream signal, for example, an MPEG-2 Transport Stream (TS) in which an MPEG-2 video signal and a Dolby AC-3 audio signal are multiplexed.

The wireless communication module of the external signal input portion 128 may wirelessly access the Internet. For the wireless Internet access, the wireless communication module may use a Wireless Local Area Network (WLAN) (i.e., Wi-Fi), Wireless Broadband (Wibro), World Interoperability for Microwave Access (WiMax), and/or High Speed Downlink Packet Access (HSDPA).

The wireless communication module may perform short-range wireless communication with other electronic devices. For short-range wireless communication, the wireless communication module may use Bluetooth, Radio-Frequency IDentification (RFID), Infrared Data Association (IrDA), Ultra WideBand (UWB), and/or ZigBee.

The external signal input portion 128 may be connected to one of various set-top boxes through at least one of the Ethernet port, the USB port, the CVBS port, the component port, the S-video port, the DVI port, the HDMI port, the RGB port, the D-sub port, the IEEE-1394 port, the S/PDIF port, and the liquid HD port and may thus receive data from or transmit data to the various set-top boxes. For example, when connected to an Internet Protocol Television (IPTV) set-top box, the external signal input portion 128 may transmit video, audio and data signals processed by the IPTV set-top box to the controller 160 and may transmit signals received from the controller 160 to the IPTV set-top box. Video, audio and data signals processed by the IPTV set-top box may be processed by the channel browsing processor 170 and the controller 160.

The term ‘IPTV’ as used herein may cover a broad range of services, depending on transmission networks, such as ADSL-TV, VDSL-TV, FTTH-TV, TV over DSL, Video over DSL, TV over IP (TVIP), Broadband TV (BTV), and Internet TV and full-browsing TV, which are capable of providing Internet-access services.

The first demodulator 130 may perform demodulation and channel decoding on the first digital IF signal DIF 1 received from the first tuner 120, thereby obtaining a first stream signal TS 1. The first stream signal TS 1 may be a signal in which a video signal, an audio signal and a data signal are multiplexed. For example, the first stream signal TS 1 may be an MPEG-2 TS signal obtained by multiplexing an MPEG-2 video signal and a Dolby AC-3 audio signal. An MPEG-2 TS signal may include a 4-byte header and a 184-byte payload.

The first stream signal TS 1 may be input to the controller 160 and may thus be subjected to demultiplexing and signal processing. The first stream signal TS 1 may be input to the channel browsing processor 170 and may thus be subjected to a channel browsing operation prior to input to the controller 160. The channel browsing operation may be described below in further detail.

In order to properly handle not only ATSC signals but also DVB signals, the first demodulator 130 may include an ATSC demodulator and a DVB demodulator.

The second demodulator 135 may receive the second digital IF signal DIF 2 from the second tuner 125 and may demodulate the second digital IF signal DIF 2, thereby generating a second stream signal TS 2. Operation of the second demodulator 135 may be almost the same as operation of the first demodulator 130.

An analog baseband video signal CVBS 2 output from the second tuner 125 may need to be digitized by the A/D converter 140.

The A/D converter 140 may convert a received analog signal to a digital signal. If the received analog signal is a video signal, the A/D converter 140 may perform sampling and quantization on the analog signal, thereby obtaining the digital video signal DV. The digital video signal DV may be a signal yet to be encoded. The digital video signal DV may be provided to the channel browsing processor 170 for processing.

The interface 150 may transmit a signal received from the user to the controller 160 and/or may transmit a signal received from the controller 160 to the user. For example, the interface 150 may receive various user input signals such as a power-on/off signal, a channel selection signal, and/or a screen setting signal from a remote controller 200 (or pointing device) and/or may transmit a signal received from the controller 160 to the remote controller 200.

The controller 160 may demultiplex an input stream signal into a number of signals and process the demultiplexed signals so that the processed signals may be output as A/V data. The controller 160 may provide overall control to the image display apparatus 100.

The controller 160 may include a demultiplexer (not shown), a video processor (not shown), an audio processor (not shown), and/or a user input processor (not shown).

The controller 160 may demultiplex an input stream signal (e.g. an MPEG-2 TS signal) into a video signal, an audio signal and a data signal.

The controller 160 may process the video signal. For example, if the video signal is an encoded signal, the controller 160 may decode the video signal. More specifically, if the video signal is an MPEG-2 encoded signal, the controller 160 may decode the video signal by MPEG-2 decoding. On the other hand, if the video signal is an H.264-encoded DMB or a DVB-handheld (DVB-H) signal, the controller 160 may decode the video signal by H.264 decoding.

The controller 160 may also adjust brightness, tint and/or color of the video signal.

The video signal processed by the controller 160 may be displayed on the display 180. Alternatively, the video signal processed by the controller 160 may be output to an external output port connected to an external output device (or external device).

The controller 160 may process the audio signal obtained by demultiplexing the input stream signal. For example, if the audio signal is an encoded signal, the controller 160 may decode the audio signal. More specifically, if the audio signal is an MPEG-2 encoded signal, the controller 160 may decode the audio signal by MPEG-2 decoding. On the other hand, if the audio signal is an MPEG-4 Bit Sliced Arithmetic Coding (BSAC)-encoded terrestrial DMB signal, the controller 160 may decode the audio signal by MPEG-4 decoding. If the audio signal is an MPEG-2 Advanced Audio Coding (AAC)-encoded DMB or DVB-H signal, the controller 180 may decode the audio signal by AAC decoding.

The controller 160 may adjust base, treble or sound volume of the audio signal.

The audio signal processed by the controller 160 may be output to the audio output portion 185 (e.g., a speaker). Alternatively, the audio signal processed by the controller 160 may be output to an external output port connected to an external output device (or external device).

The controller 160 may process the data signal obtained by demultiplexing the input stream signal. For example, if the data signal is an encoded signal such as an Electronic Program Guide (EPG), which provides broadcast information (e.g. a start time and an end time) about programs played on each channel, the controller 160 may decode the data signal. Examples of an EPG include ATSC-Program and System Information Protocol (PSIP) information and DVB-Service Information (SI). ATSC-PSIP information or DVB-SI information may be included in the header of a TS (i.e., a 4-byte header of an MPEG-2 TS).

The controller 160 may perform On-Screen Display (OSD) processing. More specifically, the controller 160 may generate an OSD signal for displaying pieces of information on the display 180 as graphic or text data based on a user input signal received from the remote controller 200 and at least one of a processed video signal and a processed data signal. The OSD signal may be input to the display 180 along with the processed video and data signals.

The OSD signal may include data such as a User-Interface (UI) screen, various menu screens, widgets, and/or icons for the image display apparatus 100.

The channel browsing processor 170 may perform channel browsing on at least one of a plurality of broadcast signals corresponding to a plurality of received channels, input image signals received from the external signal input portion 128, and/or both. More specifically, the channel browsing processor 170 may receive the first or second stream signal TS 1 or TS 2 from the first or second demodulator 130 or 135, a stream signal from the external signal input portion 128, or the digital signal DV from the A/D converter 140, demultiplex the first or second stream signal TS 1 or TS 2, and extract some of the frames of a video signal obtained by the demultiplexing. Thereafter, the channel browsing processor 170 may generate a new TS signal (i.e., a sub-stream signal TSa) by multiplexing a video signal including the extracted video frames. For example, the sub-stream signal TSa and a main-stream signal TSb may both be MPEG-2 TS signals.

The channel browsing processor 170 may output the main-stream signal TSb, which corresponds to a main video signal to be displayed in a main region of the display 180, without any processing. On the other hand, the channel browsing processor 170 may perform channel browsing on a sub-video signal, which is to be displayed in a sub-region of the display 180, thereby obtaining the sub-stream signal TSa.

The channel browsing processor 170 may extract some of the video frames of each of a plurality of broadcast signals received through a plurality of channels and re-encode the extracted video frames into a TS, thereby displaying a list of the channels on the display 180. Since the extracted video frames are displayed on the display 180 as thumbnail images, the user may intuitively identify contents of broadcast programs received through the plurality of channels.

The channel browsing processor 170 may extract some of the video frames of each of the external input signals received from the external signal input portion 128 and re-encode the extracted video frames into a stream, thereby displaying an external input image list (or external image list) on the display 180. A list of a plurality of external input image signals (or external image signals) received from a plurality of external input devices may be displayed on the display 180 as thumbnail images. Therefore, the user may intuitively identify the external input signals received from the external input devices based on the external input image list.

The channel browsing processor 170 may extract some of the video frames of each of a plurality of broadcast signals received through a plurality of channels and some of the video frames of each of various external input signals received from the external signal input portion 128 and re-encode the extracted video frames into TSs, thereby displaying a channel list and an external input image list on the display 180. Since the extracted video frames are displayed on the display 180 as thumbnail images, the user may intuitively identify the contents of broadcast programs received through the plurality of channels and the external input signals received from the external input devices.

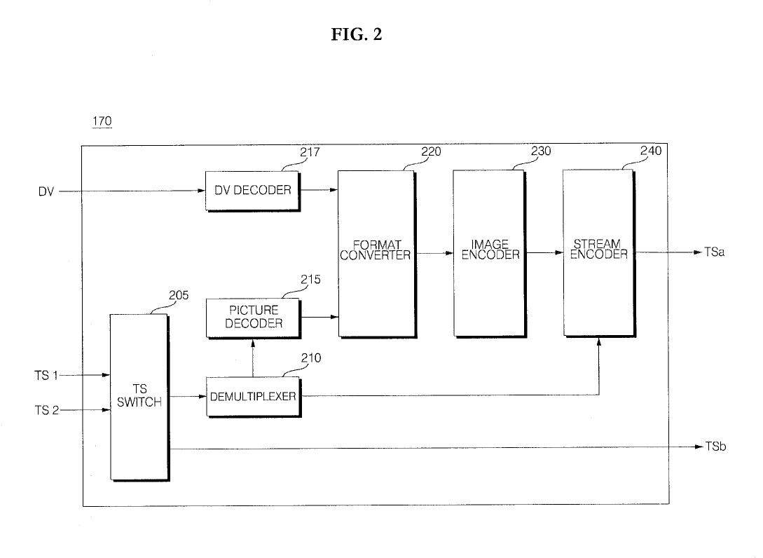

Structure and operation of the channel browsing processor 170 may be further described below with reference to FIG. 2.

The storage 175 may store various programs for processing and controlling signals by the controller 160, and may also store processed video, audio and data signals.

The storage 175 may temporarily store a video, audio and/or data signal received from the external signal input portion 128.

The storage 175 may memorize (or store) broadcast channels by a channel add function.

The storage 175 may include, for example, at least one of a flash memory-type storage medium, a hard disc-type storage medium, a multimedia card micro-type storage medium, a card-type memory, a Random Access Memory (RAM), and/or a Read-Only Memory (ROM) such as an Electrically Erasable Programmable ROM (EEPROM).

While FIG. 1 shows the storage 175 as being configured separately from the controller 160, embodiments of the present invention are not limited to this structure. For example, the storage 175 may be incorporated into the controller 160.

The image display apparatus 100 may play a file (such as a moving picture file, a still image file, a music file, and/or a text file) stored in the storage 175 to the user.

The display 180 may convert a processed video signal, a processed data signal, and an OSD signal received from the controller 160 or a video signal and a data signal received from the external signal input portion 128 to RGB signals, thereby generating driving signals. The display 180 may be implemented into any one of various types of displays such as a Plasma Display Panel (PDP), a Liquid Crystal Display (LCD), an Organic Light-Emitting Diode (OLED), a flexible display, and/or a three-dimensional (3D) display. The display 180 may also be implemented as a touch screen so that it may be used not only as an output device but also as an input device.

The audio output portion 185 may receive a processed audio signal (e.g., a stereo signal, a 3.1-channel signal or a 5.1-channel signal) from the controller 160 and output the received audio signal as voice. The audio output portion 185 may be implemented into various types of speakers.

The remote controller 200 may transmit a user input to the interface 150. For the transmission of a user input, the remote controller 200 may use communication techniques such as Bluetooth, RF, IR, UWB and/or ZigBee.

The remote controller 200 may receive a video signal, an audio signal and/or a data signal from the interface 150 and may output the received signals.

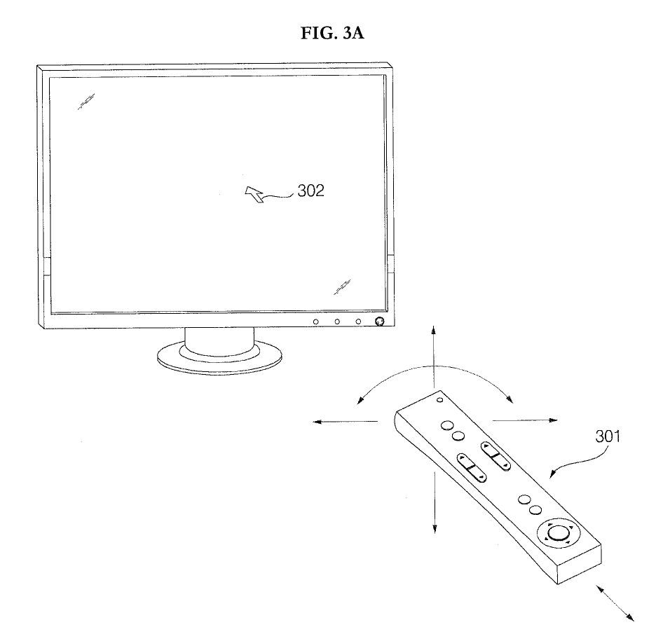

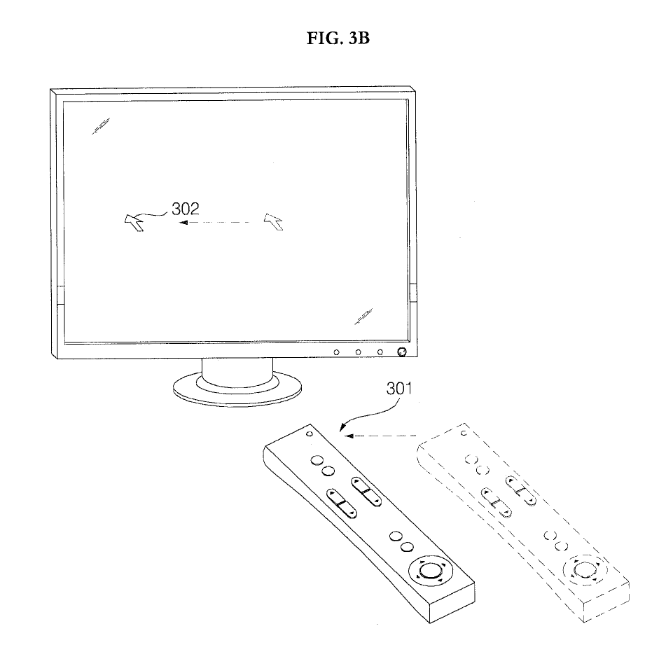

The remote controller 200 may be a pointing device, for example. A pointing device may be described in detail with reference to FIG. 3.

While FIG. 1 shows two tuners to display a channel list with thumbnail images, embodiments of the present invention are not so limited. Embodiments may also be implemented by use of a single tuner. For example, when a channel list display command is issued during receiving a broadcast channel on a selected channel, the single tuner may sequentially or periodically receive broadcast signals on all broadcast channels preliminarily memorized in the storage 175 by the channel add function. The channel list may be displayed in a full-view mode.

The image display apparatus 100 may be a fixed digital broadcast receiver capable of receiving at least one of ATSC (8-VSB) broadcast programs, DVB-T (COFDM) broadcast programs, and ISDB-T (BST-OFDM) broadcast programs or may be a mobile digital broadcast receiver capable of receiving at least one of terrestrial DMB broadcast programs, satellite DMB broadcast programs, ATSC-M/H broadcast programs, DVB-H (COFDM) broadcast programs, and/or Media Forward Link Only (MediaFLO) broadcast programs. Alternatively, the image display apparatus 100 may be a digital broadcast receiver capable of receiving cable broadcast programs, satellite broadcast programs and/or IPTV programs.

Examples of the image display apparatus 100 may include a TV receiver, a mobile phone, a smart phone, a laptop computer, a digital broadcast receiver, a Personal Digital Assistant (PDA) and/or a Portable Multimedia Player (PMP).

Various components shown in FIG. 1 may be provided in a set-top box and other components may be provided in a display device. As one example, the set-top box may include any of the following components: the first tuner 120, the second tuner 125, the external signal input portion 128, the first demodulator 130, the second demodulator 135, the A/D converter 140 and/or the channel browsing processor 170. As one example, the display device may include any of the following components: the storage 175, the interface 150, the controller 160, the audio output portion 185 and/or the display 180.

Television signals that are received by any of the components of FIG. 1 may include broadcast signals, a cable signal for a set top box and/or any type of received signal from a content provider or a cable provider, for example.

FIG. 2 is a block diagram of the channel browsing processor 170 shown in FIG. 1. Other embodiments and configurations may also be provided.

As shown in FIG. 2, the channel browsing processor 170 may include a TS switch 205, a demultiplexer 210, a picture decoder 215, a DV decoder 217, a format converter 220, an image encoder 230 (or video encoder) and a stream encoder 240.

The TS switch 205 may select one of the first stream signal TS 1 and the second stream signal TS 2, may output the selected stream signal as the main-stream signal TSb without any processing, and may transmit the other stream signal to the demultiplexer 210 as a sub-stream signal. The main-stream signal, which may correspond to a main video signal, may be displayed on almost an entire area of the display 180. The sub-stream signal, which may correspond to a sub-video signal, may be displayed only on a particular part of the display 180.

A channel list, an external input image list and/or both may be displayed in a compact-view mode in a particular area on the display 180.

The demultiplexer 210 may demultiplex the first stream signal TS 1 or the second stream signal TS 2 into a video signal, an audio signal and a data signal, output the video signal to the picture decoder 215, and output the audio signal and the data signal to the stream encoder 240 in order for the stream encoder 240 to generate a new stream signal.

The picture decoder 215 may decode at least some of the frames of the received video signal by MPEG-2 decoding, MPEG-4 decoding and/or H.264 decoding. The decoded frames may be still images and/or moving pictures. For example, the picture decoder 215 may decode an Intra-coded (I) frame or some section of the received video signal.

The DV decoder 217 may receive the digital signal DV from the A/D converter 140 and may acquire a digital image signal from the digital signal DV.

The format converter 220 may convert the format of a video signal received from the picture decoder 215 and/or the DV decoder 217. For example, the format converter 220 may change a size (or resolution) of the input image signal. The size change may depend on a number of thumbnail images in a thumbnail list displayed on the display 180. For example, as the number of thumbnail images increases, a size of the thumbnail images may decrease.

The format converter 220 may convert the input image signal to a different size based on whether the input image signal is to be displayed in a compact-view mode or in a full-view mode. The size of thumbnail images displayed in the full-view mode may be greater than the size of thumbnail images displayed in the compact-view mode. A channel list, an external input image list and/or both may be displayed on the display 180 either in the compact-view mode or in the full-view mode.

The image encoder 230 may encode the image signal received from the format converter 220 by JPEG encoding or MPEG-2 encoding. Still images or moving pictures encoded by the image encoder 230 may be displayed on the display 180 as thumbnail images.

The stream encoder 240 may re-encode or multiplex an encoded video signal received from the image encoder 230 and the audio and data signals obtained by the demultiplexing performed in the demultiplexer 210 into a stream, for example, an MPEG-2 TS.

The channel browsing processor 170 may extract some of the video frames of each of a plurality of broadcast signals and a plurality of external input signals and re-encode the extracted video frames. The re-encoded images may be displayed on the display 180 as thumbnail images in response to a user input requesting the display of a channel list or an external input image list. The user may intuitively identify contents of broadcast programs received from various channels or external input signals provided by various external input devices (or various external devices).

FIGS. 3A and 3B illustrate examples of the remote controller 200 (or pointing device) shown in FIG. 1.

As shown in FIGS. 3A and 3B, the remote controller 200 may be a pointing device 301. The pointing device 301 may transmit or receive RF signals to or from the image display apparatus 100 according to an RF communication standard. As shown in FIG. 3A, a pointer 302 representing movement of the pointing device 301 may be displayed on the image display apparatus 100.

The user may move the pointing device 301 up and down, back and forth, and side to side and/or may rotate or move the pointing device 301. The pointer 302 may move in accordance with movement of the pointing device 301, as shown in FIG. 3B.

As shown in FIG. 3A, if the user moves the pointing device 301 to the left, the pointer 302 may move to the left accordingly. The pointing device 301 may include a sensor capable of detecting motions. The sensor of the pointing device 301 may detect movement of the pointing device 301 and transmit motion information corresponding to a result of the detection to the image display apparatus 100. The image display apparatus 100 may determine the movement of the pointing device 301 based on the motion information received from the pointing device 301, and may calculate coordinates of a target point to which the pointer 302 should be shifted in accordance with the movement of the pointing device 301 based on a result of the determination.

As shown in FIGS. 3A and 3B, the pointer 302 may move according to whether the pointing device 301 moves vertically or horizontally and/or rotates (and/or moves). The moving speed and direction of the pointer 302 may correspond to the moving speed and direction of the pointing device 301.

The pointer 302 may move in accordance with movement of the pointing device 301. Alternatively, an operation command may be input to the image display apparatus 100 in response to the movement of the pointing device 301. That is, as the pointing device 301 moves back and forth, an image displayed on the image display apparatus 100 may be gradually enlarged or reduced. This exemplary embodiment of the present invention does not limit the scope and spirit of other embodiments of the present invention.

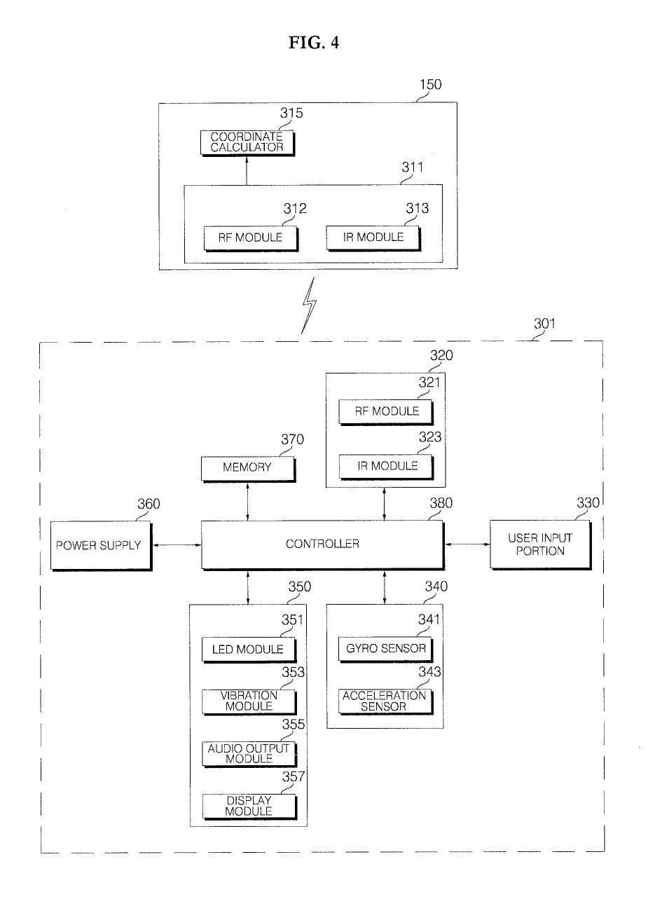

FIG. 4 is a detailed block diagram of the pointing device 201 shown in FIGS. 3A and 3B and the interface 150 shown in FIG. 1. As shown in FIG. 4, the pointing device 301 may include a wireless communication module 320, a user input portion 330, a sensor portion 340, an output portion 350, a power supply 360, a memory 370 (or storage), and a controller 380.

The wireless communication module 320 may transmit signals to and/or receive signals from the image display apparatus 100. The wireless communication module 320 may include an RF module 321 for transmitting RF signals to and/or receiving RF signals from the interface 150 of the image display apparatus 100 according to an RF communication standard. The wireless communication module 320 may also include an InfraRed (IR) module 323 for transmitting IR signals to and/or receiving IR signals from the interface 150 of the image display apparatus 100 according to an IR communication standard.

The pointing device 301 may transmit motion information regarding movement of the pointing device 301 to the image display apparatus 100 through the RF module 321. The pointing device 301 may also receive signals from the image display apparatus 100 through the RF module 321. The pointing device 301 may transmit commands to the image display apparatus 100 through the IR module 323, when needed, such as a power on/off command, a channel switching command, and/or a sound volume change command.

The user input portion 330 may include a keypad and/or a plurality of buttons. The user may enter commands to the image display apparatus 100 by manipulating the user input portion 330. If the user input portion 330 includes a plurality of hard-key buttons, the user may input various commands to the image display apparatus 100 by pressing the hard-key buttons. Alternatively or additionally, if the user input portion 330 includes a touch screen displaying a plurality of soft keys, the user may input various commands to the image display apparatus 100 by touching the soft keys. The user input portion 330 may also include various input tools other than those set forth herein, such as a scroll key and/or a jog key.

The sensor portion 340 may include a gyro sensor 341 and/or an acceleration sensor 343. The gyro sensor 341 may sense movement of the pointing device 301, for example, in X-, Y-, and Z-axis directions, and the acceleration sensor 343 may sense a moving speed of the pointing device 301.

The output portion 350 may output a video signal and/or an audio signal corresponding to a manipulation of the user input portion 330 or a signal transmitted by the image display apparatus 100. The user may easily identify whether the user input portion 330 has been manipulated or whether the image display apparatus 100 has been controlled based on the video signal and/or the audio signal output by the output portion 350.

The output portion 350 may include a Light Emitting Diode (LED) module 351, a vibration module 353, an audio output module 355 and a display module 351. The LED module 351 may be turned on or off whenever the user input portion 330 is manipulated or whenever a signal is received from or transmitted to the image display apparatus 100 through the wireless communication module 320. The vibration module 353 may generate vibrations, the audio output module 355 may output audio data, and the display module 357 may output video data.

The power supply 360 may supply power to the pointing device 301. If the pointing device 301 is kept stationary for a predetermined time or longer, the power supply 360 may, for example, reduce or cut off supply of power to the pointing device 301 in order to save power. The power supply 360 may resume the power supply when a specific key on the pointing device 301 is manipulated.

The memory 370 may store various application data for controlling or driving the pointing device 301. The pointing device 301 may wirelessly transmit signals to and/or receive signals from the image display apparatus 100 in a predetermined frequency band with the aid of the RF module 321. The controller 380 of the pointing device 301 may store information in the memory 370 regarding the frequency band used for the pointing device 301 to wirelessly transmit signals to and/or wirelessly receive signals from the paired image display apparatus 100, and may then refer to this information for a later use.

The controller 380 may provide overall control of the pointing device 301. For example, the controller 380 may transmit a signal corresponding to a key manipulation detected from the user input portion 330 and/or a signal corresponding to a motion of the pointing device 301, as sensed by the sensor portion 340, to the interface 150 of the image display apparatus 100.

The interface 150 may include a wireless communication module 311 that wirelessly transmits signals to and/or wirelessly receives signals from the pointing device 301, and a coordinate calculator 315 that calculates a pair of coordinates representing the position of the pointer 302 on the display screen that is to be moved in accordance with the movement of the pointing device 301.

The wireless communication module 311 may include an RF module 312 and an IR module 313. The RF module 312 may wirelessly transmit RF signals to and/or wirelessly receive RF signals from the RF module 321 of the pointing device 301. The IR module 313 may wirelessly transmit IR signals to and/or wirelessly receive IR signals from the IR module 321 of the pointing device 301 according to the IR communication standard.

The coordinate calculator 315 may receive motion information regarding movement of the pointing device 301 from the wireless communication module 320 of the pointing device 301 and may calculate a pair of coordinates (x, y) representing the position of the pointer 302 on a screen of the display 180 by correcting the motion information for possible errors such as a user's handshake.

A signal received in the image display apparatus 100 from the pointing device 301 through the interface 150 may be transmitted to the controller 160. The controller 160 may acquire information regarding movement of the pointing device 301 and information regarding a key manipulation detected from the pointing device 301 from the signal received from the interface 150, and may control the image display apparatus 100 based on the acquired information.

The image display apparatus 100, the remote controller 200, and/or the pointing device 301 (being a kind of the remote controller 200) are shown in FIGS. 1 to 4 as having a number of components in a given configuration. However, in other embodiments, the image display apparatus 100, the remote controller 200, and/or the pointing device 301 may include fewer components or additional components than those shown in FIGS. 1-4. Two or more components of the image display apparatus 100, the remote controller 200, and/or the pointing device 301 may be combined into a single component or a single component thereof may be separated into two more components in alternative embodiments. Functions of the components of the image display apparatus 100, the remote controller 200, and/or the pointing device 301 as set forth herein are illustrative in nature and may be modified to satisfy the purposes of a given application, for example.

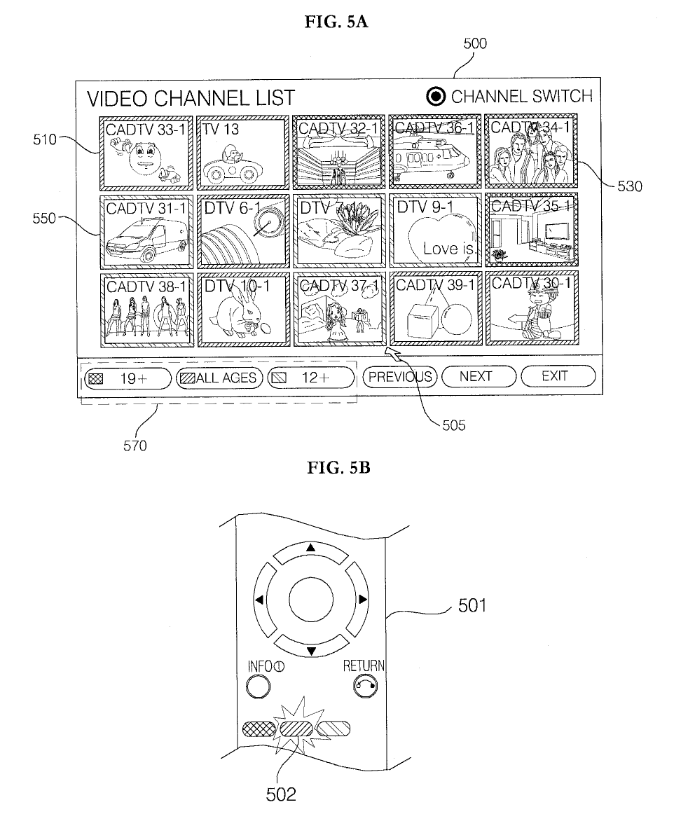

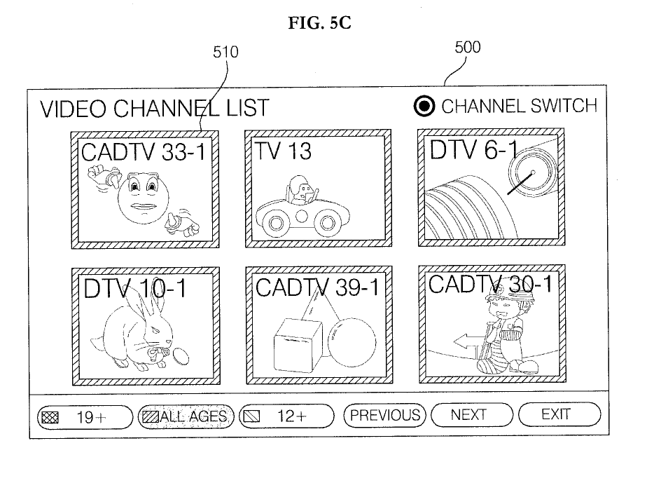

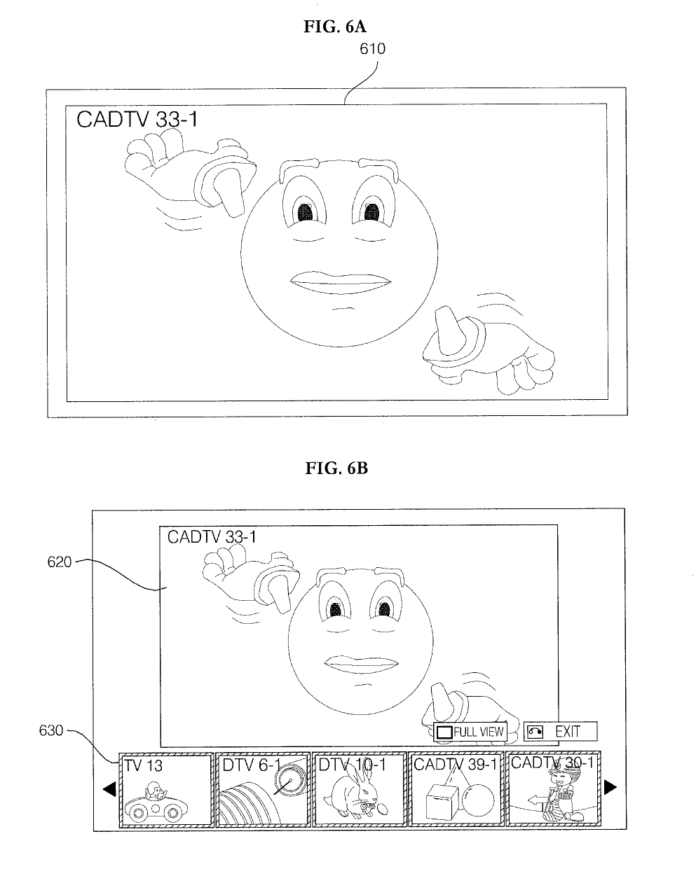

FIGS. 5A to 7B show examples of screens displayed on the display 180 according to exemplary embodiments of the present invention. Other embodiments and configurations are also within the scope of the present invention. Different colors may be represented by lines slanted in different directions in FIGS. 5A, 5C and 6B.

As shown in FIG. 5A, when a channel list display command is issued, a thumbnail list 500 with thumbnail images corresponding to broadcast signals (or television signals) received on channels may be displayed on the display 180. “Video Channel List” may be displayed in an upper part of the display 180, for example. While the thumbnail images are displayed across an entire area of the display 180 in a full-view mode, embodiments of the present invention are so not limited. The thumbnail images may be displayed in a particular area of the display 180 in a compact-view mode.

As the thumbnail list 500 including a plurality of thumbnail images is displayed on the display 180, the user may intuitively identify contents of broadcast programs played on different channels.

The thumbnail images of the thumbnail list 500 may be still images and/or moving pictures. The thumbnail images may be currently received images and/or pre-stored images. The thumbnail images may be images that have been processed and extracted by the channel browsing processor 170.

The thumbnail images may correspond to broadcast signals (or television signals) received on preliminarily memorized broadcast channels. The preliminarily memorized broadcast channels may be all broadcast channels and/or some preferred broadcast channels. Thumbnail images may be generated or provided according to a channel list stored in a channel map and thumbnail images of the preferred broadcast channels may be generated with priority by scanning the preferred broadcast channels.

The thumbnail images of the thumbnail list 500 may be displayed and classified by a group. Different groups of thumbnail images may be represented by different color information, for example. Thus, the thumbnail images may be displayed along with the color information to identify the groups of the thumbnail images.

As shown in FIG. 5A, the thumbnail images may be framed in different colors based on their respective groups, thereby enabling the user to intuitively identify the different groups of the thumbnail images by their frame colors. Thus, user convenience may increase.

The thumbnail images may be grouped according to ratings of programs corresponding to the thumbnail images in FIG. 5A. The ratings may indicate appropriate ages for viewing programs.

As one example, thumbnail images 510 of a content group rated for all ages may be framed in green, thumbnail images 550 of a content group rated for kids aged 12 and older may be framed in yellow, and thumbnail images 530 of a content group restricted to persons aged 19 and older may be framed in red. Other colors and/or groups may also be provided.

The colors indicating the classifications may be changed by changing default values set for the classifications. FIG. 5A shows three groups of thumbnail images although embodiments are not so limited. The number of thumbnail image groups may vary based on a classification criterion.

The color information may at least partially overlap with the thumbnail images. The color information may take the form of intuitive colored shapes corresponding to the classifications, such as icons. The icon may overlap in the thumbnail image or numbers (within the thumbnail image). The color information may also be displayed in a shape similar to a color key of the remote controller 200 (or pointing device).

With the thumbnail list 500 displayed on the display 180, at least one of the thumbnail images corresponding to received broadcast signals may be updated. An updated thumbnail list including the updated thumbnail image may be newly displayed on the display 180.

When a command to move a cursor or a pointer 505 is issued with the thumbnail list 500 displayed on the display 180, the cursor or the pointer 505 may move in a direction such as up, down, left, right, and/or the like. If an item is selected after movement of the cursor or the pointer 505, an operation corresponding to the selected item may be performed. The movement of the cursor or the pointer 505 and the item selection may be implemented by input of a directional key and a selection key of the remote controller 200, or by an operation input and a selection input of the pointing device 301.

The thumbnail list 510 displayed on the display 180 may include an edit menu based on the displayed thumbnail images at a bottom and/or in any other part of the display 180.

The edit menu may include menu items “Previous” for displaying a thumbnail list previous to the displayed thumbnail list, “Next” for displaying a thumbnail list following the displayed thumbnail list, and/or “Exit” for shifting from “Video Channel List” to another menu. The edit menu may include menu items “Channel Lock” (not shown), “Zoom” (not shown), and/or “Compact View” (not shown). A selected thumbnail image may be locked so that it can not be edited by selecting Channel Lock, a thumbnail image or a thumbnail list may be displayed in an enlarged or reduced manner by selecting Zoom, and an image of a selected channel may be displayed in a part of the display 180, while thumbnail images are displayed in another part of the display 180 by selecting Compact View.

The thumbnail list 510 may include color menu items 570 corresponding to the color information to identify the thumbnail image groups, for selecting the thumbnail groups, as shown in FIG. 5A.

If one of the color menu items 570 is selected, a list of thumbnail images may be further displayed of a group identified by the color information that corresponds to the selected color menu item 570.

For example, upon selection of the color menu item 570 corresponding to green color information, a thumbnail list including only thumbnail images corresponding to the green color information may be displayed on the display 180.

If a specific thumbnail image is selected, an image screen with contents of a broadcast signal corresponding to the selected thumbnail image may be displayed on the display 180.

As shown in FIG. 5A in which Red (R) represents a 19+ rating, Yellow (Y) represents a 12+ rating, and Green (G) represents an all ages rating, the color menu items 570 may be displayed along with classifications that the color information indicates. Since colors can be assigned to various classifications, the user may forget a classification that some color represents. As the color menu items 570 are displayed along with the classifications corresponding to them, user convenience may be further increased.

Upon selection of one of the color menu items 570, screens with the images of broadcast signals corresponding to thumbnail images of the group identified by the color information corresponding to the selected color menu item 570 may be further displayed on the display 180. If the group includes a single thumbnail image, a screen with the image of a broadcast signal corresponding to the thumbnail image may be displayed on the display 180.

More specifically, when the group includes only one thumbnail image, a screen with the image of a broadcast signal corresponding to the thumbnail image may be displayed without the need for displaying a thumbnail list, thereby enabling the user to rapidly view an intended image. If the group includes a plurality of thumbnail images, screens with the images of broadcast signals corresponding to the thumbnail images may be directly displayed on the display 180 by a user setting.

The color menu items 570 may be selected by use of the cursor or the pointer 505. One of the color menu items 570 may be selected by moving the cursor to the color menu item 570 using a directional key of the remote controller 200 or moving the pointer 505 to the color menu item 570 through a manipulation of the pointing device 301. In another embodiment, a group including a thumbnail image may be selected by dragging the thumbnail image to a predetermined area using the pointing device 301.

The color information may correspond to color keys of the remote controller 200. As shown in FIG. 5B, a remote controller 501 (or pointing device) may have color keys 502 corresponding to red (R), green (G) and yellow (Y), for example. The color keys 502 may be colored in red, green and yellow, respectively. Other colors and/or keys may also be used.

If one of the color keys 502 is selected, a thumbnail list may be further displayed of thumbnail images of the group identified by the color information corresponding to the selected color key 502.

For example, FIG. 5C shows a thumbnail list including the thumbnail images 510 of the group identified by the green color information when the color key 502 corresponding to G is selected from the remoter controller 501 (or pointing device) shown in FIG. 5B.

If a color key corresponding to a group including only one thumbnail image is selected, a screen with the image of a broadcast signal corresponding to the thumbnail image may be further displayed on the display 180.

Accordingly, a thumbnail image may be identified as belonging to one of a plurality of groups. Each group may be classified based on at least one of a prescribed setting or data of a television signal. The thumbnail images belonging to one group may be differentiated based on at least one of color or icon from the thumbnail images belonging to another group. The one group may be differentiated based on color by color shading surrounding the thumbnail image or based on the thumbnail image being provided with a different color as compared to the another group.

FIGS. 6A and 6B are diagrams showing a compact-view function according to an exemplary embodiment of the present invention. Other embodiments and configurations are also within the scope of the present invention.

When a thumbnail list is requested during an image screen 610 being displayed as shown in FIG. 6A, a “Video Channel List” may be displayed in a compact-view mode as shown in FIG. 6B. FIG. 6B shows that an on-going image screen 620 is displayed in a part of the display 180, whereas a thumbnail list 630 of thumbnail images corresponding to a plurality of broadcast signals may be displayed in another part of the display 180. When one of the thumbnail images is selected by the cursor, or the pointer of the pointing device 301, a channel corresponding to the selected thumbnail image may be played.

When the compact-view function is implemented, thumbnail images corresponding to all broadcast signals may be displayed and scanned. Therefore, the displaying and updating of the thumbnail images may be slow. Due to the trend of an increase of a number of broadcast channels, the user may take a large amount of time to detect a desired broadcast program and access the broadcast program by the compact-view function.

A thumbnail list 630 of the thumbnail images of a group identified by color information corresponding to a selected color menu item or a selected color key of the pointing device may be displayed in a particular area of the display 180.

The resulting reduction of displayed thumbnail images in number may shorten the time required for the user to detect a thumbnail image. The displayed thumbnail images may be controlled to be updated above all other thumbnail images, thereby increasing a thumbnail image update speed and thus enabling the user to view the up-to-date thumbnail images.

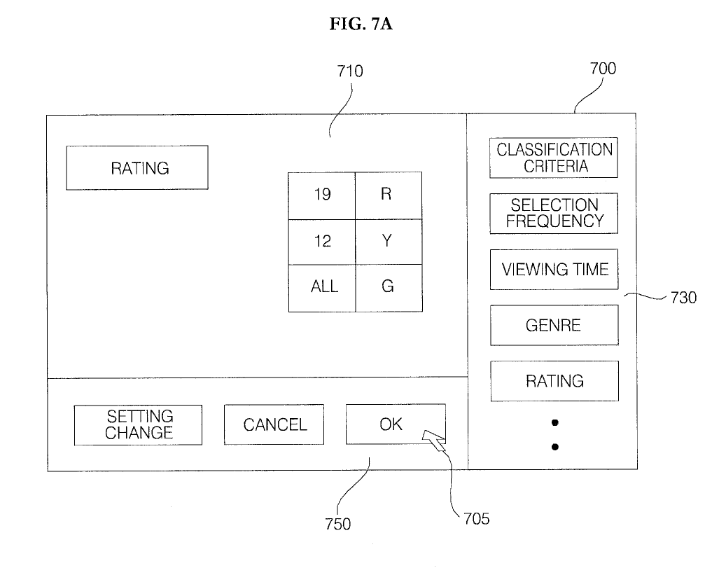

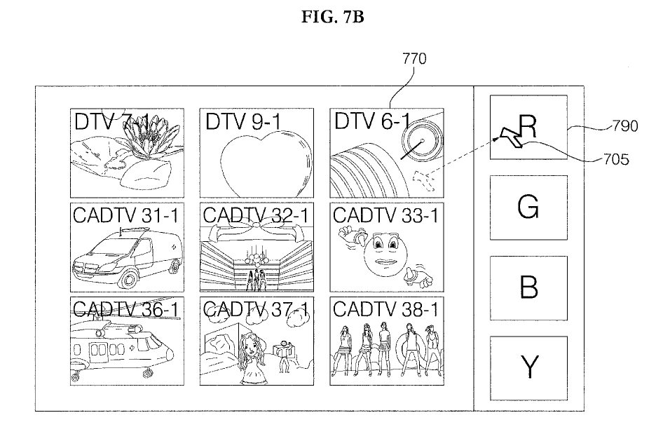

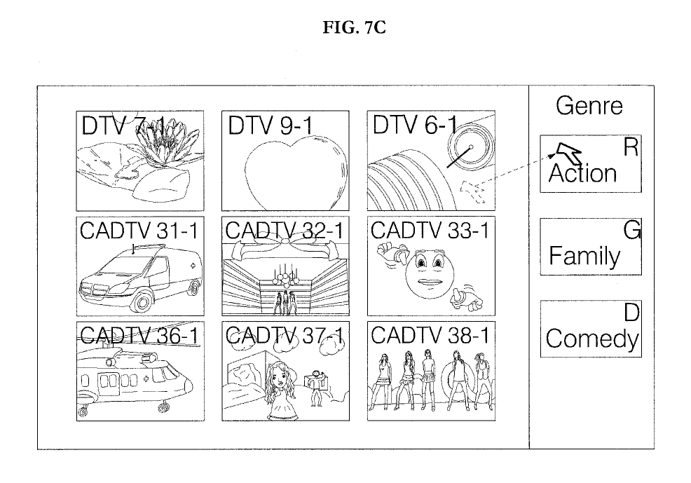

FIGS. 7A-7C are diagrams illustrating a method for setting a classification criterion according to an exemplary embodiment of the present invention. Other embodiments and configurations may also be within the scope of the present invention.

FIG. 7A shows a method for setting a classification criterion by means of a classification criterion menu 700.

The classification criterion menu 700 may include a detailed item window 710 in which sub-menus and setting information are displayed, a classification criterion selection window 730 in which a list of classification criteria are displayed, and a command window 750 in which a command such as OK or Cancel are entered.

Ratings may be used as a classification criterion in FIG. 7A. More specifically, default values for ratings 19 and above, 12 and above, and all ages may be set to colors R, Y and G, respectively. The color information corresponding to the respective ratings may be changed by the user.

Classification criteria on which a plurality of thumbnail images are grouped may include at least one of a popularity rank, a selection frequency, and/or a viewing time for received broadcast signals. For the popularity of broadcast signals, service providers, countries, local channels, and/or contents may be ranked.

The selection frequency and the viewing time of a broadcast channel may be how often and how long the broadcast channel or contents of the broadcast channel are selected in the image display apparatus 100.

The selection frequencies and the viewing times of broadcast channels may be set separately according to users, although the broadcast channels are played in the same image display apparatus. For example, family members such as father, mother, daughter, son, etc. may enjoy different broadcast channels or contents according to their tastes in a single image display apparatus in their home. The selection frequencies and viewing times of broadcast channels may be stored for respective users based on log-ins through their individual accounts or by face recognition and provided later to the users. Thus, a user convenience may be increased.

The thumbnail images may be classified based on at least one of criteria including language, broadcasting type, rating, genre, director, service provider, program time, and/or casting.

Broadcasting types may correspond to transmission techniques such as ATSC, DVB, etc. Broadcasting types may be based on aspect ratios such as 16:9, 4:3, etc. Considering there are broadcast contents available in various languages such as English and French, contents may be classified by languages. The same contents may be serviced in different languages including English and Spanish. Therefore, even the same contents may be classified according to languages available to them, thus allowing the user to identify a language in which to enjoy the contents. The term “language” may cover a subtitle as well as voice in its meaning.

If the user sets a sports channel to R as a classification, thumbnail images corresponding to sports channels may be displayed along with R color information so that the user may easily identify the sports channels.

A plurality of thumbnail images may be grouped by a user setting. FIG. 7B is a diagram showing a method for setting a classification criterion based on a user setting.

As shown in FIG. 7B, the user may drag an intended thumbnail image 770 to an area 790 marked with R by a pointer 705 of the pointing device so as to classify the thumbnail image 770 as having R color information. The user may drag the intended thumbnail image 770 to other areas, such as areas marked by one of G, B or Y, for example.

FIG. 7C is a diagram showing a method for setting a classification criteria based on a user setting. As shown in FIG. 7C, the user may drag an intended thumbnail image to one of the displayed genres (e.g. action, family or comedy). Alternatively, the user may drag the pointer 705 from one of the displayed genres to one of the displayed thumbnail images. Accordingly, the classification may be set based on the user setting.

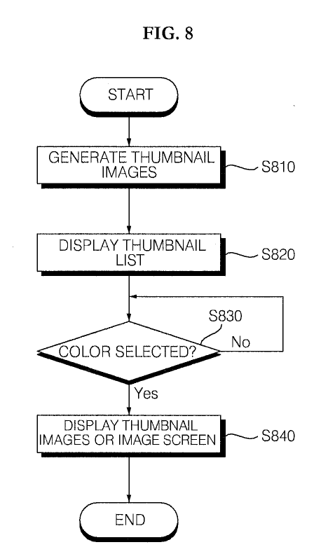

FIG. 8 is a flowchart of a method for operating the image display apparatus according to an exemplary embodiment of the present invention. Other operations, orders of operations and embodiments are also within the scope of the present invention.

As shown in FIG. 8, a plurality of thumbnail images may be generated based on received broadcast signals in operation S810 and a list of the thumbnail images may be displayed on the display in operation S820. The thumbnail images may be displayed along with their color information to identify groups into which the thumbnail images are classified.

When a color menu item or a color key of the remote controller (or pointing device) is selected and thus a color corresponding to the color menu item or color key is selected in operation S830, thumbnail images of a group corresponding to the color are displayed or screens with images of broadcast signals corresponding to the thumbnail images are displayed according to a user setting in operation S840.

The operation method may further include storing the selection frequencies and the viewing times of the received broadcast signals. As the selection frequencies and the viewing times of broadcast signals that the user has selected and viewed are stored, information about the broadcast signals may be provided to the user based on their statistics.

The selection frequencies and the viewing times of the received broadcast signals may be stored separately for individual users. This may mean that preferences of individual users sharing a single image display apparatus may be separately stored. In case of a family, for example, a current family member using the image display apparatus may be identified by an account through which the image display apparatus is logged in, and/or by face recognition. A viewer record may be stored for the family member so that user-customized information may be provided later.

To store the selection frequencies and the viewing times of received broadcast signals, for example, whenever a specific channel is played on a main screen of the display in the image display apparatus, the selection frequency of the specific channel may be incremented by 1 and its viewing time may start to be calculated. When the specific channel is switched to another channel, the viewing time calculation may be discontinued and the viewing time up to that moment may be stored for the specific channel. This operation may be repeated for the switched channel. With respect to the selection frequencies and the viewing times, the statistic information may be stored daily, weekly and/or monthly. The user may freely set a time period for which the selection frequencies and the viewing times are calculated.

Instead of the above frequency and time accumulation scheme, the user may rapidly select a channel or contents at a given time based on data about the selection frequencies and the viewing times of received broadcast channels at the same given time on the previous day and/or in the previous week.

The above described embodiments may discuss broadcast signals used to create the thumbnail images. These embodiments may use other types of television signals such as a cable signal for a set top box, a satellite signal and/or any type of received signal from a content provider or cable provider.

An image display apparatus may include a display, a tuner (or receiver) for receiving an input signal, and a controller for controlling a thumbnail list of a plurality of thumbnail images to be displayed on the display. The controller may characteristically control the thumbnail images to be displayed along with color information to identify groups into which the thumbnail images are classified. The image display apparatus may further include a remote controller or pointing device with color keys corresponded to the color information.

An operation method of an image display apparatus according to the foregoing exemplary embodiments may be implemented as a code that can be written on a computer-readable recording medium and may thus be read by a processor. The computer-readable recording medium may be any type of recording device in which data is stored in a computer-readable manner.

Examples of the computer-readable recording medium may include a ROM, a RAM, a CD-ROM, a magnetic tape, a floppy disc, an optical data storage, and/or a carrier wave (e.g., data transmission through the internet). The computer-readable recording medium may be distributed over a plurality of computer systems connected to a network so that computer-readable code may be written thereto and executed therefrom in a decentralized manner. Functional programs, code, and/or code segments needed for realizing embodiments may be construed by one of ordinary skill in the art.

According to at least one exemplary embodiment, a user may identify contents of broadcast signals (or television signals) received on channels intuitively. As thumbnail images are displayed and/or classified, a user convenience is increased. Also, the user may access an intended channel in a shorter time.

At least one embodiment may provide an image display apparatus and an operation method of the image display apparatus that enables a user to intuitively identify information about a broadcast signal (or a television signal) received on a channel.

A method may be provided for operating an image display apparatus. The method may include generating (or providing) a plurality of thumbnail images based on received broadcast signals (or television signals), and displaying a thumbnail list including the plurality of thumbnail images on a display. The plurality of thumbnail images may be displayed along with color information to identify groups into which the plurality of thumbnail images are classified.

An image display apparatus may be provided that includes a display, a tuner (or receiver) for receiving broadcast signals (or television signals), and a controller for controlling a thumbnail list including a plurality of thumbnail images that are generated based on the received broadcast signals (or received television signals). The controller may control the plurality of thumbnail images to be displayed along with color information that identifies groups into which the plurality of thumbnail images are classified.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for providing a menu for a display, comprising:
generating a plurality of thumbnail images based on received television signals, the thumbnail image being at least one of a still image or a moving image; and
providing a thumbnail list for output on a display, the thumbnail list including a portion or all of the plurality of thumbnail images,
wherein a thumbnail image is identified as belonging to one of a plurality of groups, each group being classified based on at least one of a prescribed setting or data of the television signal, and
wherein based on the groups, the thumbnail images belonging to one group are differentiated based on at least one of color or icon from the thumbnail images belonging to another group.

2. The method according to claim 1, wherein the prescribed setting is a user setting.

3. The method according to claim 1, wherein the prescribed setting is based on a selection frequency, a viewing time, a genre or a rating.

4. The method according to claim 1, wherein the one group is differentiated based on color by color shading surrounding the thumbnail image or based on the thumbnail image being provided with a different color as compared to the another group.

5. The method according to claim 1, wherein the plurality of thumbnail images are framed in different colors corresponding to the groups into which the plurality of thumbnail images are classified.

6. The method according to claim 1, wherein the plurality of thumbnail images at least partially overlap color information.

7. The method according to claim 1, wherein the one group is differentiated based on color by using one of a plurality of color keys of a pointing device.

8. The method according to claim 7, further comprising:
upon selection of one of the color keys of the pointing device, displaying a thumbnail list including thumbnail images of the one group identified by color information corresponding to the selected color key.

9. The method according to claim 1, wherein the thumbnail list includes one or more color menu items corresponding to color information to identify the groups of the plurality of thumbnail images.

10. The method according to claim 9, further comprising:
upon selection of one of the color menu items, displaying a thumbnail list including thumbnail images of a group identified by color information corresponding to the selected color menu item.

11. The method according to claim 1, further comprising displaying the thumbnail list at least in a part of a display.

12. The method according to claim 1, further comprising displaying a thumbnail list including an updated version of at least one of the plurality of thumbnail images on a display.

13. An image display apparatus comprising:
a display;
a receiver for receiving television signals; and
a controller for providing a plurality of thumbnail images based on received television signals, the thumbnail image being at least one of a still image or a moving image, the controller for providing a thumbnail list for output on the display, the thumbnail list including a portion or all of the plurality of thumbnail images,
wherein the thumbnail image is identified as belonging to one of a plurality of groups, each group being classified based on at least one of a prescribed setting or data of the television signal, and
wherein based on the groups, the thumbnail images belonging to one group are differentiated based on at least one of color or icon from the thumbnail images belonging to another group.

14. The image display apparatus according to claim 13, wherein the prescribed setting is a user setting.

15. The image display apparatus according to claim 13, wherein the prescribed setting is based on a selection frequency, a viewing time, a genre or a rating.

16. The image display apparatus according to claim 13, wherein the one group is differentiated based on color by color shading surrounding the thumbnail image or based on the thumbnail image being provided with a different color as compared to the another group.

17. The image display apparatus according to claim 13, wherein the plurality of thumbnail images are framed in different colors corresponding to the groups into which the plurality of thumbnail images are classified.

18. The image display apparatus according to claim 13, wherein the plurality of thumbnail images at least partially overlap color information.

19. The image display apparatus according to claim 13, further comprising a pointing device that includes one or more color keys to correspond to color information.

20. The image display apparatus according to claim 19, wherein the one group is differentiated based on color by using at least one color key of the pointing device.

21. The image display apparatus according to claim 17, wherein upon selection of one of the color keys of the pointing device, the display displaying a thumbnail list including thumbnail images of a group identified by color information corresponding to the selected color key.

22. The image display apparatus according to claim 13, wherein the thumbnail list includes one or more color menu items corresponding to color information to identify the groups of the plurality of thumbnail images.

23. The image display apparatus according to claim 22, wherein upon selection of one of the color menu items, the display displaying a thumbnail list including thumbnail images of a group identified by color information corresponding to the selected color menu item.
